(19) United States
(12) Patent Application Publication
(10) Pub. No.: US 2006/0167933 A1
(43) Pub. Date: Jul. 27, 2006

(54) International standard question number

(76) Inventor: Hassan Behbehani, Kuwait (KW)

Correspondence Address: Hassan Behbehani, P.O. Box: 1262 Safat 13013, Safat, Kuwait, KW

(21) Appl. No.: 11/030,123

(22) Filed: Jan. 7, 2005

(51) Int. Cl. G06F 17/00

(52) U.S. Cl. 707/103 R

(57) ABSTRACT

People are looking for information because they need answers of their questions. The information seeking need is raised whenever a question is aroused and information seeker does not know the answer of this question or more detailed answer is required. The presented technique reveals a bi-directional classification technique to classify the contents according to for what people are looking exactly i.e. answer for a particular question. Every question is assigned a unique identification number internationally under which all the contents are classified which have answer of this internationally unique question.

### REFERENCES

1. ISBN Users' Manual International edition by International ISBN Agency Berlin 2001 Fourth, revised edition
2. Simplify & Sort for Better Searches by Constance J. Petersen for Enterprise Development Magazine (http://www.smartisans.com/articles/web_search.aspx)
3. Text Information Retrieval Systems by Charles T. Meadow, Bert R. Boyce, Donald H. Kraft for Rowman & Littlefield Publishers, Inc. ISBN:
4. Library Research Models: A Guide to Classification, Cataloging, & Computers by Thomas Mann for Oxford University Press ISBN: 019509395×
5. Youth Information-Seeking Behavior: Theories, Models, and Issues by Mary K. Chelton, Colleen Cool for Rowman & Littlefield Publishers, Inc. ISBN: 081084981×
6. The World Discovers Cataloging: Conceptual Introduction to Digital Libraries, Metadata and the Implications for Library Administrations (Roger Brission)

### BACKGROUND OF THE INVENTION

The resulting growth of information, publications or library's Website means that, like the World Wide Web itself, users are finding it increasingly difficult to find needed information. How does one gain access to a reading assignment from Electronic Reserves? In what database could I search for anthropological literature? And so on. At the same time, the larger public, academic, and special libraries now have Web-accessible databases, both bibliographic and fulltext, numbering in the hundreds, and it will not be long before this number will reach the thousands.

Institutions like Cornell's innovative Mann Library originally worked with the concept of a ‘gateway’ to organize their offerings with hierarchical links, but as the number of their digital resources grew the gateway concept, at least in its more static form as hierarchically linked Web pages, became less and less effective. More recently many libraries are attempting to meet the challenge of exploding digital resources by developing more sophisticated navigation systems for their Websites, and currently they are addressing this challenge with such techniques as ‘tabbed’ pages, frames, cascading style sheets, and site searching tools.

Parallel to the growth of information and electronic contents Websites are the rising number of complaints in the popular media relating to the growing difficulties of finding needed information on the Internet. The now familiar mantra that the Web is tumbling into chaotic anarchy can be read again and again, alongside the growing frustration expressed with the fruitless time wasted in searching for needed information. In the few short years of its existence, the World Wide Web has grown from a means for specialists to share technical documents to an increasingly important platform for research and scholarship, indeed as a means for general social communication. In a number of areas it is rapidly supplanting paper-based publication as the primary carrier in disseminating information. In their essential role as collectors and organizers of information, librarians are being called upon to address the critical challenge of bringing the explosion of Web-based information under control, and they are experiencing this first-hand with their own Websites.

But what precisely should libraries be organizing and controlling? A particular collection or collections of electronic texts? A database of electronic journal material? Web-based resources that a library's collection development staff individually select? The library's or its home institution's Website? Or perhaps, as one hears in the popular media, the World Wide Web itself?

While libraries continue to catalog ‘traditional’ materials (i.e., non-networked information on relatively stable media) as they have now for decades, they recognize they must somehow come to terms with the new information resources proliferating around them. As with the development of digital libraries, librarians are addressing the question of organization and control of Internet-based materials from different perspectives. One approach has been to follow traditional library practices and to treat networked materials in the same way a library catalogs materials in other formats. Led by OCLC's experimental InterCat project, catalogers have adapted their rules and procedures to the cataloging of Internet-based resources. The MARC format, along with the Anglo-American Cataloging Rules, have been supplemented with new fields and rules for handling materials found on the Web, and numerous libraries around the country have been adding records for Internet resources to their online catalogs. Adapting MARC and AACR2 for cataloging Internet-based materials has resulted in interesting challenges, not only because of the variety of resources being cataloged, but also because of their dynamic, indeed volatile, nature. The descriptive cataloging rules found in AACR2 were of course originally developed for the much more static world of printed material, and in applying these rules to Websites catalogers have quickly realized that the rules for description can only, with difficulty, adequately describe the irregularly changing, dynamic nature of many of these sites.

Even as they experiment with adding records of Internet-based materials to their catalogs, however, libraries are well aware that creating full-level records for their OPACs can only be used to a limited degree. Traditional cataloging for library OPACs is resource-intensive, and cataloging staffs are already over-burdened with handling existing workflows of books and other established formats. Attempting to integrate new cataloging workflows for the growing number of Internet based resources is a daunting prospect for most cataloging departments, and library administrations are well aware of this situation. For most library professionals, this has led to a situation not unlike the proverbial holding one's finger over the crack of an overflowing dam about to burst. A handful of libraries have approached this problem by significantly relaxing the standards that currently exist for full-level AACR2/MARC cataloging, and allowing minimal-type OPAC records to be created for Internet-based resources. Attempting to automate as much of this process as possible, these libraries have employed software programs and automated scripts for converting HTML-based data into a basic MARC record. The records are then intellectually enhanced and added to the library OPAC. Libraries are learning, however, that this strategy is not without serious shortcomings. Once a MARC record is added to the OPAC, a static record is created for an item that itself is dynamic and in many cases highly subject to change, with the record and resource object residing independently of one another in different electronic (and often administrative!) realms. Libraries taking this approach to providing control of Internet-based resources have thus accepted the risk of filling a relatively ‘clean’ database under authority control—their OPACs—with records that possess a high likelihood of becoming meaningless over time. Just as it was possible to speak of a variety of digital library ‘cultures’, so too can one describe the various approaches that have developed in addressing the organization and access issues for Internet-based resources. In an experimental mode, libraries initially went out and cataloged Websites and other Internet-based resources, without seriously considering the question of systematic library selection. These resources were freely accessible on the Internet, after all, so it no longer seemed important if the library actually owned the material. The call for ‘cataloging the Net’ appeared to take hold of the imagination here, and it was logical to begin somewhere by selecting appropriate (in many cases the catalogers themselves decided what to catalog for the OPAC) sites to catalog. In another realm, publishers and other commercial vendors began offering libraries large online databases of full-text digital materials, both monographic and serial in nature, and here too the need to provide more than just collection-level access to these materials was obvious.

Librarians were well-aware of this latter problem, of course, because of their experience with creating access for major microform sets. In all of these cases, a new MARC field, the 856 ‘linking’ field, was created to allow Web-based OPACs a place for a ‘hot-linkable’ field in a record to allow direct access to an electronic resource. At the same time that libraries experimented with strategies for cataloging Internet-based resources for their OPACs, computing specialists were rapidly developing the means for automatically indexing the universe of Web resources, as well as making available increasingly sophisticated search engines. While MARC-based cataloging could be considered a traditional approach to controlling a library's materials, the Internet ‘spiders’ and search engines developed by information scientists could be thought of as the other end of the spectrum, that of employing innovative automation techniques in harnessing the power of the latest computer technology. Many library administrators and other technical service specialists thus began to question the wisdom of using traditional cataloging methods to bring the Web under control when computer scientists and their automated methods appeared to be making such progress in creating their own solutions. This situation thus led to a series of poignant questions in regard to the organization and control of Internet-based resources: should Web-based materials be cataloged in a traditional library manner—effective but resource-intensive—for the online catalog using AACR2 and the MARC format? Or could a library rely on both commercial indexing/search services like Yahoo!, and its own spiders and search engines, for providing to Web-based materials? Traditional cataloging on the one hand, and automated indexing with boolean searching on the other, seemed such radically different approaches to dealing with the same problem—are they in any way compatible, or is it coming down to an either/or proposition? The solution here, as it was with the concept of the digital library, is to focus on the primary library functions of selection, acquisitions, organizing, and making materials accessible. But how these functions should be integrated into the electronic environment as they relate to organization and control? How should librarians reconceptualize their purpose in this matter, and how should they structure their approach to providing effective control over Internet-based materials? Libraries unquestionably want to organize and make the electronic materials they select easily accessible to patrons, but is cataloging them for the OP AC the best means to do this? And what advantage will be for the end users, the most important entity off course. In a manner similar to learning to distinguish and assertively define its digital existence from the general medium of the World Wide Web itself, libraries must also develop an under standing of the role they must play in organizing and providing access to digital materials. As with digital libraries the answer, in terms of a library's strategic planning, can be found in how it structures its institutional relationship to the Web. Rather than arbitrarily attempting to catalog Web resources, libraries must learn to use their limited resources in providing control in a way that is most advantageous to their own institutional purpose and mission. Stated succinctly, the answer must be an administrative one, and not one driven by reactively responding to rapidly developing technology. As we will see, what is proposed in this paper is a differentiated response to providing effective organization and control to Web resources.

Though solutions need to be driven by administrative planning, libraries will nonetheless need to develop a keen understanding of how the developing Web influences the directions they can take in providing access to digital resources. Librarians must also continue to develop their roles as active players in the development of the Web as a publishing medium. New software releases, new or updated Web protocols and standards, as well as larger inter-institutional initiatives will continue to have a significant influence on administrative decision-making. While librarians and computer scientists experimented with such efforts as the OCLC InterCat project, they recognized that the seeming dichotomy between resource-intensive, traditional cataloging, and automated indexing techniques had led to an untenable situation. As the explosive growth and dynamic nature of the Web became clearer, both traditional cataloging and automatic indexing, for differing reasons, took on the air of becoming exercises in futility. On the one hand ‘link rot’, or the tendency for Websites to change their URLs, or Internet addresses, had become the nemesis of the legacy, MARC-based library catalogs, which of course are static in nature.

On the other hand, as the Web continued to double its size every few months the Web crawlers that harvested and indexed Web resources were decreasing precipitously in their effectiveness as search tools. The unsophisticated, relatively crude indexing of Web resources was clearly not able to handle this rapid growth of Web-based data. Information specialists recognized early on in this development that a powerful approach to addressing this dilemma would be to apply the strengths of both traditional cataloging techniques and automated indexing into a single solution. If HTML as a markup language could be made more discriminating, more intelligent, in handling text, then indexing software could be made to specifically target particular fields in its harvesting activity. Much like the powerful search capabilities of a MARC-based catalog, search engines could then be configured to search whatever fields one indexed with the Web crawlers used to harvest data. The obvious platform for handling more sophisticated fields already existed in SGML, a higher level mark up language from which HTML itself originated. But just as HTML is a very simple mark-up language used for basic presentation of text with minimal complexity, SGML represents the other end of the spectrum in complexity and sophistication. The solution was to take the most useful essential qualities from SGML and integrate them into a next generation HTML. The result, as many in the information profession now know, is the proposed markup language XML. While preserving backward compatibility with the millions of pages already marked up using HTML, XML can be characterized as an ‘intelligent’ HTML. The source of this characterization is the ability for XML, like SGML, to allow a Website designer or a professional community to define the types of tags used in a Website. This is accomplished through the Document Type Definition, or DTD, which permits one to specify with great precision through the use of tags defined in the DTD the nature of any given body of data. Thus, the qualities of precision and flexibility in specifying tags in XML have introduced a whole new level of sophistication in the markup language used on the Web. This in turn has provided the means for the strategic application of library cataloging theory to the problems of organization and access now plaguing the Web. XML will act as the rational infrastructure for library cataloging principles to be applied to the world of Web resources in a way that promises not only to greatly improve the current situation for indexing and searching the Web, but to also be cost effective. This body of theory, known as metadata theory, will work in tandem with the digital library concept in creating a much more ordered development of library Websites in particular, and the greater World Wide Web in general.

The past couple of years have been productive ones in advancing possible solutions for the information chaos existing on the World Wide Web. The close working collaboration of librarians and information scientists is apparent in the directions that Web research and development have been taking recently, and strategies for bringing a greater degree of coherent structure to the Web are now actively discussed. Descriptive metadata such as Dublin Core represents an attempt at uniting the best of the worlds of traditional cataloging on the one hand and information science on the other, for it strategically combines a degree of intellectual control of headings (through metatags and some level of authority control) with the efficient indexing and searching performed by computers. Since Dublin Core data can reside in the header of a Web page marked up in XML, spiders and search engines can be designed to harvest this information for Web-based databases. In fact, it is conceivable that this strategic scenario could become as powerful a database system as the legacy MARC-based databases, complete with all the latter's functionality.

A library Website developed entirely in XML, using a sufficient subset of Dublin Core descriptive metadata elements, will provide a library administration a powerful environment for developing a distinctive institutional digital library. XML allows an administration to define the type of metadata tags used through a DTD, which can then be used consistently throughout an organization. XML-conformant databases and search engines can then be configured to index and search the tags specified in a Website's DTD. It will thus be possible for a library administration to configure its own distinctive virtual presence as a digital library through metadata. Grounding and structuring a digital library through metadata will go far in bringing the wealth of information resources made available digitally under ‘bibliographic’ control, and as such provide users with a powerful means for quickly finding needed information.

To attain an effective degree of organizational control over an institutional Website, a library will need to integrate a metadata infrastructure and policy into its strategic plan for Website development. This will include incorporating a descriptive metadata scheme like Dublin Core, in which all the administrative pages in a library's Website will possess some kind of descriptive metadata specified by a library's DTD. The library's Web search engine could then be configured to specifically search the elements in the descriptive metadata. The library's Website would then be developed around the metadata-based search tools and navigation features integrated into the Website. As Websites grow, the principles of navigation, search, and discovery will become just as important as the actual information made available through the Website.

As the World Wide Web continues to establish itself as a powerful new force in society libraries should follow industry in recognizing the strategic value of mirroring its institutional existence in the digital environment, and to exploit the Web's potential in acting as a primary gateway, or ‘portal’, to a library's resources and services. Because of this strategic value, administration of the institutional Website needs to be uniform and coordinated throughout the organizational structure. This also means that all of the various models, or types, of digital libraries need to be harmonized into the whole of the organizational Web design and structure. Viewed within this institutional framework, a critical component to the library's Website is, along with selection, the library's most important raison d'être: organization and access. New computing technologies have opened up a range of possibilities for library administrations to respond to the challenge of bringing its resources under organizational control, and to aid the user in better finding needed information. With these technologies libraries are no longer constrained to the option of either adding full-level cataloging records to their OPACs, or, alternatively doing nothing to enhance access. Library catalogs and other databases are far more powerful than their predecessors in allowing for effective importing and exporting of data, as well as for converting to other database formats. Other inexpensive and readily available database packages, such as Microsoft Access and Filemaker Pro, can be used for creating metadata for specific kinds of material or collections. HTML- or XML-conformant metadata schemes such as Dublin Core can form the basis for Web-based metadata registries, which in turn can be used as the basis of a sophisticated navigation and search system for a library's Website. As a library's needs and organizational structure change, the data from these various databases can be converted and moved from database to database, depending on the level of control one wishes to maintain with particular types of resources.

Library administrations can develop a differentiated strategic infrastructure for bibliographic, or resource, control by using these database applications for specific kinds of material or purposes. A library's OPAC, for example, as possessing the library's ‘cleanest’, most secure data with a relatively high degree of integrity, can administratively retain this identity in library operations. This would mean, for example, that only materials selected, acquired, and thus owned by the library would have full-level MARC records created for the OPAC. With Web spider and indexing software, such as Open Text's Livelink, a metadata registry based on schema such as Dublin Core could be created for Web-based resources. Depending on how a library administration wishes to profile the registry, such a Web-based database could include only resources that the library owned or controlled on its own servers, or it may include Internet materials that are external, or outside administrative control of the library. Unless the library employed automatic link validation software, however, which would regularly go out and confirm the existence of the links from cataloging record to resource, there is a risk that many records in the registry would become invalid over time. Other database programs, such as Filemaker Pro, could be set up for a variety of special databases or indexes that a library may maintain for users. These indexes would generally belong to what libraries have called ‘vertical file’ material in the past, and may include local databases of a CD collection, CD-ROMs, special archives, and the like. Such packages like Filemaker Pro lend themselves well to decentralized, or distributed cataloging, since they can be set up, with appropriate security, for creation and input on the Web itself. This would allow the various units, or branches, of a library (or library system) to create and maintain their own special databases.

The danger once considered a serious problem by librarians—of uncontrolled proliferation of library databases can now be addressed through effective Web design, since all of these databases can be accessed via a library's Website, and even from a single search interface. Current technologies, using Z39.50 and other techniques such as CGI scripting, now allow a library's systems office to create cross database search interfaces for patrons, allowing them to specify their search domain from the user interface.

But all the above techniques ignored one important factor i.e. end users. They gave the importance to contents rather than people who need these contents. These techniques classify and catalog the contents according to nature of contents not according to nature of contents which will be used to search these existing contents. Why people search because to find a question that needs an answer or to find an answer of the question people have i.e. either way people are having a question that needs to be answered. Every information requirement is a question in reality. People when are seeking for some specific information, they are interested to find an answer for the question which encourages the people for information seeking. People are actually looking answers for their questions.

Also contents of any sort of publication are not without any purposes. These contents are actually answers of some specific questions either in form of textual descriptions or questions and answers formats. The publications or contents mostly combined in a group under the title and these contents supposed to be relevant with the title and every publication is of limited scope not necessarily covering every thing about the title or subject to which a publication belongs. When people are looking for information about something as described earlier actually looking for answer of their questions its not easy to identify weather a specific publication may answer their question though subject and title are relevant until reader explores the publication.

In short, people are looking for information because they need actually answer of their question. And the contents of publication are actually answers of some questions. So there is need of a system that can classify the contents according to questions so people can find the answers of these questions quickly.

For example reader is looking for information such as “What are social impacts of divorce?” There may be thousands of titles available for the subject “Divorce” but it would be extremely difficult and time consuming to identify the required title that has reader's exactly wanted information from thousands of titles. By thinking in terms of strategically employing a variety of database solutions, library administrations can develop a much more differentiated solution to bibliographic control in their particular institutions. Rather than attempting to awkwardly develop resource-intensive and expensive workflows for creating MARC/AACR2 bibliographic records for all materials the library wishes to bring under bibliographic control, it now can administratively define levels of control and treatment through the particular types of databases it creates and makes available on the Web. With these possibilities, a library could develop a comprehensive strategic plan for bibliographic control that would both address the explosion of new information resources being made available, and create levels of control that would be cost-effective. In such a scenario, bibliographic control could be graphically represented as a series of concentric rings, with the MARC-based library OPAC representing the innermost, central ring. This, of course, would visually represent the highest degree of bibliographic control. Each subsequent ring, as one moved away from center, would represent database solutions and workflows that possessed decreasing levels of bibliographic control. The outermost ring, for example, could represent a metadata registry, with a minimum number of Dublin Core elements, for external Web resources, or it may simply represent a harvester/indexing software suite that maintains fully automated control of a Web domain. This latter possibility would thus possess no intellectual control of the indexed metadata, and libraries would expect users to rely entirely on keyword searching for finding needed material.

These problems leads the necessity of having standard question number or unique identification number worldwide from which reader can identify quickly weather required information exists in a publication or not and what are the publications that can have answers for particular question. As reader finds the required information or answer of the question quickly then time can spent on research, study and other related activities such as reader can analyze the publication and can select the publication with high quality of contents. Therefore the presented technique comes in a way that classifies the information in the form of questions and answers.

The presented system would have some obvious benefits such as but not limited to;

The ISQN will be unique identifier for a specific question internationally so researchers, students and other involved entities will be easy able to locate required information.

It will save much time which can be spent in other activities such as analyzing the found information than only locating the information.

It would be more flexible way to sort out quality contents.

Updated research information would be easy available to interested entities Can boost book sales as readers will be able to locate information quickly in more depth that will boost the confidence of customers that are spending money exactly for their required information

Will encourage writers and publishers to write material in scope of the subject rather than filling the pages

If books enlist what ISQNs this book can answer, reader will be able easily understand the nature and material of book

Libraries profit from copy-cataloguing by ISQN

### BRIEF SUMMARY OF THE INVENTION

While some may have initially considered an essay dealing with conceptual foundations an interesting but perhaps inconsequential exercise, it is hoped this essay demonstrated that in times of radical change strategic conceptualization is critical to the development of a library's future planning and management. How we mentally structure and ‘visualize’ a library's role in the unfolding digital revolution is critical to the future of libraries as institutions. In visualizing this role, librarians should focus on the library's traditional functions and to rethink these functions in the new digital environment. Considered in a similar light, digital libraries are more than an archival repository of preserved materials or an electronic text center, and likewise metadata will become much more than simply a means of cataloging a special digital collection.

The presented technique holds the potential for fully integrating the essential functions of the library into the digital environment, and strategically centering the library for the critical role it should play in the coming digital society of the 21st century and reveals a method to assign an internationally unique identification number or unique id to specific sort of questions related with a particular industry or specific subject. The idea is to assign a internationally unique number to every question so that researchers, readers, students and other interested entities can easily locate their required information and can choose high quality contents with the found material. This is an idea to assign internationally unique identification number to single question internationally is revealed known hereby as ISQN (International Standard Question Number). The questions which are same semantically, logically with linguistic and other differences undergo the same internationally unique identification number though a language code can be included or appended in the unique number itself.

### BRIEF DESCRIPTION OF THE DRAWINGS

No Drawing is accompanying with this specifications

### DETAILED DESCRIPTION OF THE INVENTION

With increasing frequency the popular computer magazines outline a critical challenge, a key issue, to further the progress of the Information Revolution. Articles from these magazines typically claim that the Internet is quickly reaching a critical mass, and unless significant effort is exerted to find better ways of bringing the explosively growing body of Web-based information under organizational control, the Information Revolution will come to a screeching halt as dramatically as it began.

Though the writers of these articles aren't aware of it, what they characterize in these articles is nothing more than what cataloging librarians have methodically practiced for decades now. Both the problem as seen from their perspective—how to control large bodies of information, and the perceived solution—by applying both descriptive and intellectual ordering principles to these bodies, could easily have been taken from a cataloging textbook. It seems that the world has discovered cataloging, and it has hit primetime. The authors of these articles don't call it cataloging of course. Increasingly, however, the architects of the Internet—telecommunications specialists, information and computer scientists, and business systems managers—are discovering that cataloging librarians possess a wealth of knowledge and experience in taming the chaotic information domains like those found on the World Wide Web.

Over the past years the word metadata has increasingly circulated both in the cataloging departments of libraries worldwide of a variety of information organizations. In their work with cataloging Internet-based resources, catalogers have made metadata part of their working vocabulary, while at the same time Web developers regularly speak of HTML as metadata. Though on a superficial level it would appear that they are using the word differently and in different contexts, a common conceptual foundation unites them. That the MARC record itself could inherently be considered as sharing a common theoretical foundation as the World Wide Web may come as a surprise to many, and this makes a discussion of metadata concepts even more relevant and interesting for librarians.

Metadata as a concept, however, can apply not only to the particular fields of a MARC record, it also applies to the MARC record itself. Like the old catalog card, the MARC record as a whole acts as a signifier, or representation, of a work in the form of an object, be it a book, a music CD, or an electronic journal. This signifier has come to be known in cataloging as a ‘surrogate’. In the traditional card environment, the metadata structure was depicted by simple means, such as through mechanisms like specific indentation of lines on the card, and through labels like ‘series’. However, because the card catalog was so much more forgiving of inconsistencies, even errors, than in the world of computers, the body of ‘metadata’ theory surrounding traditional cataloging was correspondingly rudimentary. As we know, computers possess little tolerance for ambiguity—one has to be very specific and concrete in delineating the structure and identifying the nature of a record's fields. Compare the several volumes necessary for describing the USMARC format, comprising many hundreds of pages, to the few pages of instructions necessary for describing the organization of data in the catalog card!

As we know, MARC as a body of metadata encompasses much more than the labeling of fields with the three-digit numbers that has become a part of our working vocabulary. There are the detailed instructions on how these fields are created, their order, the subfields that are contained in each field, and the like. In fact, these instructions are now referred to as a syntax, much like the linguistic structures of ‘natural’ languages such as English or French. These instructions are distinct from the rules that regulate the structure of the contents of a record's fields. We recognize the similarity between metadata and natural language by referring to these rules as the semantics of a record.

It wasn't MARC, however, that made metadata if not quite a household word, then a fashionable term bantered about in the mass media today. Rather, it was the army of amateur ‘publishers’ who over the past several years have learned HTML to create pages for the World Wide Web.

As the World Wide Web has grown, database developers have realized that simple indexing of every word and keyword searching are too primitive of an approach in creating a sufficient search tool for finding needed information. Developers have increasingly recognized that two critical features are needed to tame the Web: first, a means of identifying or marking key information so that spiders can more strategically index only this tagged information, and second, standards and specialized lists need to be employed to create greater consistency of information once it has been specially tagged. For librarians this sounds suspiciously familiar, and indeed, once one begins to follow the discussions of such concepts and principles, the contours of a very MARC- and AACR2-like system of cataloging principles become apparent.

As described earlier there are many systems that group or similar contents and information as discussed in Background of this specifications. There are also techniques used by libraries and public organizations to classify the contents so that required information is easy to locate. For example, Some libraries provide catalogues based on publishers, titles, genre, subject, authors and other parameters. But all these parameters have one common problem that is user required information is rottenly much difficult to find until reader goes through all the classified information and still there is no guarantee weather user required information exist in the material or not.

One universal truth is that no body wastes time in searching without any information requirement. Every information requirement actually is raised from a question. People when are locating the information, they are not interested to find everything about specific theme but actually are looking for an answer for the question which encourages the people for information seeking. People are actually looking answers for their questions.

Also contents of any sort of publication are not without any purposes. These contents are actually answers of some specific questions.

In short, people are looking for information because they need actually answer of their question. And the contents of publication are actually answer of some questions. So it makes sense and is possible to classify the contents in form of questions and provide people really what they are looking for i.e. answers of their questions!

The question/answer scheme is also has one benefit that it is the atomic classification of any sort of contents.

In the light of above discussion here a new concept of international standardization is being introduced that is able to classify or group the same sort of information and contents under a unique number worldwide so that people easily can access and identify the required information.

The unique number assigned to a specific question is unique to all the same sort of questions that have similar semantic and logical meanings internationally no matter what is language is used and in what way the question was asked.

For example consider the question “What are reasons of Earthquake” Semantically this question may be asked in hundreds of ways and in many languages such as

what are reasons of earthquake?

what are reasons of seismic activity?

what are causes of earthquake?

Why earthquakes occur?

What are basis of earthquake?

What are grounds for earthquakes?

What are basis of earthquake . . . Etc

All the above questions will go under the same unique number or ISQN because all are targeting the same semantic meanings.

Similarly if we consider another example such as the question “What are social impacts of divorce” Again this question can also be asked in number of ways and in many languages. Some of possible ways are

What are social impacts of separation?

What are social shocks of divorce?

What are social shocks of break up?

What are social blows of divorce?

What are communal impacts of separation?

What are communal shocks of divorce?

What are communal blows of separation?

How divorces effect the social life of people?

How divorces effect the community?

What are communal blows of separation? etc

The questions produced above are for just explanatory purposes. The said invention will also be able to handle the text that can be semantically considered as question. This text is not question actually but semantically can be considered as question. For example, the text “Reasons of EarthQuake” and this is logically having the same meanings as “What are reasons of earthquake”. Anyway one question can be asked actually in numerous ways. The examples are here only for the purpose how this method can be effective as it combines hundreds and thousands of questions under one number and from this number user can easily locate the target of information.

The unique number or ISQN assigned to a question internationally is variable in length and is customizable. The number format is also customizable and may include or appended with additional code such as language code so that people are able to identify contents according to their language interest.

ISQN may also contain the subject information and this subject may be further drilled down to atomic division in form of questions. The ISQN number is also variable in length but after standardization all the ISQN will be of same length and same format. The ISQN may also be alphanumeric and may contain special characters as well such as dashes, hyphens and spaces etc. The ISQN may use other numbering system as well such as hex, octal or roman numbering systems.

Once the ISQN is assigned to a specific question as described earlier it will be unique always. Any printed materials, publications or electronic contents that have answer to specific ISQN are grouped under one ISQN. So one ISQN may have hundreds of books or publications attached with it. So one publication or electronic publication or some sore of material having contents that can deliver some sort of information in text, audio or video form may have multiple ISQN numbers because one publication may answer many questions.

What I claim as my invention is:

1. A method to assign an internationally unique identification number or unique id to specific sort of questions related with a particular industry or specific subject, comprises the steps of:
analyzing the material under process
categorizing the said material information into questions and answers
categorizing each question
Assign a internationally unique identification number to each question
Release the numbers for assigning to publications and other materials

2. A method as claimed in claim 1, wherein analyzing the material under process step material means any sort of contents such as published books, journals, thesis, images, alphabatecal character(s) and/or numerals . . . etc.

3. A method as claimed in claim 1, wherein the said material may be analyzed manually or through some other electrical, electronic or mechnaical devices such as computer, scanners . . . etc.

4. A method as claimed in claim 1, wherein categorizing the said material information step may be performed maually or automatically in some way.

5. A method as claimed in claim 1, wherein questions can be categorized into one or multiple categories.

6. A method as claimed in claim 1, wherein questions can have categories and further sub categories. Each further sub category may have again sub categries and so on.

7. A method as claimed in claim 1, wherein the internationally unique identifcation number's format is customizable.

8. A method as claimed in claim 1, wherein the internationally unique identifcation number's assigned to each question is unique including all the previously assigned unique numbers.

9. A method as claimed in claim 1, wherein the internationally unique identifcation number's may include additional parameters for easy identification such as language code to identify the language of the question. These parameters are considered as additional parameters and are not part of standard unique number itself.

10. A method as claimed in claim 1, wherein the questions which are same semantically, logically with linguistic and other differences undergo the same internationally unique identification.

11. A method as claimed in claim 10, wherein a additional code such as language code can be included or appended in the unique number itself.

12. A method to assign an internationally unique identification number or unique id to specific sort of questions wherein unique id again are assigned to material to identify exactly what answers of questions the said material can provide related with a particular industry or specific subject, comprises the steps of:
analyzing the material under process
categorizing the said material information into questions and answers
categorizing each question
analyze and identify previously generated unique ids for question
Assign a internationally unique identification number to each question that has not been assigned previously a unique id
Release the numbers for assigning to publications and other materials

13. A method as claimed in claim 12 wherein the said unique ids can be generated automatically or manually according to specified certain criteria.

14. A method as claimed in claim 12 wherein the said unique ids can be generated automatically or manually according to specified unique id format.

15. A method to keep record of internationally unique identification numbers or unique ids to specific sort of questions wherein unique ids again are assigned to material to identify exactly what answers of questions the said material can provide related with a particular industry or specific subject, comprises the steps of:
A database or some other sort of data repository to store unique ids Wherein the said database is also able to store other related information with unique ids such as material to which these numbers were assigned . . . etc and specified format of unique ids according to which unique ids are generated.

16. A method as claimed in claim 15, wherein the said database can shared and distributed over network, world wide web, computers and other devices capable of storing data such as palm devices, computer chips, computer memory, cd, dvd, tape . . . etc.

17. A method as claimed in claim 16, wherein the said database can be used as an online forum.
